(19) United States
(12) Patent Application Publication
(10) Pub. No.: US 2008/0255745 A1
(43) Pub. Date: Oct. 16, 2008

(54) Method and Device for Controlling an Electronic Brake of a Vehicle

(76) Inventors: Wolfgang Bay, Frankfurt (DE); Mathias Fernengel, Dietzenbach (DE); Frank Sader, Frankfurt am Main (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/063,829

(22) PCT Filed: Aug. 21, 2006
(86) PCT No.: PCT/EP06/65490

§ 371 Date: Feb. 14, 2008

(30) Foreign Application Priority Data
Aug. 29, 2005 (DE) 10 2005 040 878.8
May 24, 2006 (DE) 10 2006 024 427.3

(51) Int. Cl. B60T 13/74

(52) U.S. Cl. 701/79

(57) ABSTRACT

In a method for controlling an electromechanical brake of a vehicle, the electromechanical brake having a braking element (12), an electric actuator (14) and a pressing element (18), the pressing element is arranged and is coupled to the electric actuator (14) so that it can be pressed against the braking element (12) by the electric actuator (14). An actual value of a linear acceleration (A_ACT) of the vehicle is determined and the actuator (14) is triggered as a function of the actual value of the linear acceleration (A_ACT) of the vehicle.

### CROSS-REFERENCE TO RELATED APPLICATIONS

This application is a U.S. national stage application of International Application No. PCT/EP2006/065490 filed Aug. 21, 2006, which designates the United States of America, and claims priority to German application number 10 2005 040 878.8 filed Aug. 29, 2005 and German application number 10 2006 024 427.3 filed May 24, 2006, the contents of which are hereby incorporated by reference in their entirety.

### TECHNICAL FIELD

The invention relates to a method for controlling an electronic brake of a vehicle.

### BACKGROUND

A wide variety of embodiments of electronic brakes is known from the prior art. They can for example be differentiated as follows into
Electrohydraulic brakes,
Electropneumatic brakes and
Electromechanical brakes.

In the case of electromechanical brakes in particular, brakes of this type which have a self-energizing effect are known. They are also referred to as self-energizing electromechanical brakes. The following embodiments indeed mostly refer to self-energizing electromechanical brakes; however, there are no particular technical objections against using the invention in all other electronic brake systems.

Vehicle is taken below to mean any kind of mobile apparatus.

Especially for use in motor vehicles said electronic brakes must have a control, which guarantees that during a normal braking, the two brakes of a vehicle axle brake heavily enough for the vehicle to keep to the path desired by the driver of the vehicle. Uneven braking results in the vehicle deviating from the path desired by the driver of the vehicle, which is to be avoided for safety reasons. In addition it should be ensured that the electronic brake brakes in precisely the way desired by the driver of the vehicle. However, the deceleration behavior of a brake can vary greatly, in particular as a function of the temperature and the surface condition of the friction surfaces. In particular electromechanical brakes that have a self-energizing behavior need a good control, since the ratio of the applied actuator force to the actually generated friction force depends very greatly on the friction coefficients between the friction surfaces.

A self-energizing electromechanical brake is known from DE 101 51 950 A1 with a braking element, an electric actuator that generates an actuating force, a friction pad actuated by the electric actuator on which the electric actuator acts, thereby pressing said pad against the braking element and a device for detecting the moment of friction occurring during braking, which comprises means for measuring the friction force or the force of the actuator respectively and for determining the normal force acting between the brake disk and the friction pad is well. In this case, the quality of the braking control very much depends on how precisely the friction force or the force of the actuator and the normal force between the pressing element and the braking element can be determined.

### SUMMARY

A precise controlling of an electronic brake can be achieved according to an embodiment by a method for controlling an electronic or electromechanical brake of a vehicle the brake comprising a braking element, an electric actuator, and a pressing element, which is arranged in such a way and is coupled to the electric actuator in such a way that it can be pressed against the braking element by means of the electric actuator, and the method comprising the steps of: determining an actual value of a linear acceleration of the vehicle, and triggering the actuator as a function of the actual value of the linear acceleration of the vehicle.

According to a further embodiment, a setpoint value of the linear acceleration of the vehicle can be predetermined, and the actuator can be triggered in such a way that the actual value adapts itself to the setpoint value of the linear acceleration of the vehicle. According to a further embodiment, an actual value of a rate of yaw of the vehicle can be determined, and the setpoint value of the linear acceleration of the vehicle can be determined as a function of the actual value of the rate of yaw of the vehicle. According to a further embodiment, an actual value of the rotational acceleration of a driving mechanism of the vehicle can be determined; an actual value of the rate of yaw of the vehicle can be determined; from the actual value of the linear acceleration and from the actual value of the rate of yaw of the vehicle, an estimated value of the rotational acceleration of the driving mechanism of the vehicle can be determined; as a function of the actual value of the rotational acceleration and the estimated value of the rotational acceleration of the driving mechanism of the vehicle, an estimated value of the braking torque of the driving mechanism of the vehicle can be determined; a setpoint value of the braking torque of the driving mechanism of the vehicle can be predetermined; and the actuator can be triggered in such a way that the estimated value adapts itself to the setpoint value of the braking torque of the driving mechanism of the vehicle. According to a further embodiment, a difference value between the vehicle speed and the rolling speed of the driving mechanism of the vehicle can be determined as a function of the actual value of the rotational acceleration and the estimated value of the rotational acceleration of the driving mechanism of the vehicle, and the estimated value of the braking torque of the driving mechanism of the vehicle can be determined from the difference value between the vehicle speed and the rolling speed of the driving mechanism of the vehicle. According to a further embodiment, the actual value of the linear acceleration of the vehicle can be determined by means of a driving stability system of the vehicle. According to a further embodiment, the actual value of the linear acceleration of the vehicle can be determined by means of an anti-lock brake system of the vehicle. According to a further embodiment, the actual value of the rotational acceleration of the driving mechanism of the vehicle can be determined by means of an anti-lock brake system of the vehicle.

According to another embodiment, in a device for controlling an electronic or electromechanical brake of a vehicle, the brake comprises a braking element, an electric actuator, and a pressing element, which is arranged in such a way and is coupled to the electric actuator in such a way that it can be pressed against the braking element by means of the electric actuator. The device is operable to determine an actual value of a linear acceleration of the vehicle, and to trigger the actuator as a function of the actual value of the linear acceleration of the vehicle.

According to a further embodiment, the electronic brake can be an electromechanical brake, which is configured in the form of a wedge brake and the pressing element has a wedge element.

According to yet another embodiment, a method for controlling an electronic or electromechanical brake of a vehicle, wherein the brake comprises a braking element, an electric actuator, and a pressing element, which is arranged in such a way and is coupled to the electric actuator in such a way that it can be pressed against the braking element by means of the electric actuator, the method may comprise the steps of: determining an actual value of a rotational acceleration of a driving mechanism of the vehicle, and triggering the actuator as a function of the actual value of the rotational acceleration of the driving mechanism of the vehicle.

According to a further embodiment, a setpoint value of the rotational acceleration of the driving mechanism of the vehicle can be predetermined, and the actuator can be triggered in such a way that the actual value adapts itself to the setpoint value of the rotational acceleration of the driving mechanism of the vehicle. According to a further embodiment, an actual value of a rate of yaw of the vehicle can be determined and the setpoint value of the rotational acceleration of the driving mechanism of the vehicle can be determined as a function of the actual value of the rate of yaw of the vehicle. According to a further embodiment, the actual value of the rotational acceleration of the driving mechanism of the vehicle can be determined by means of a driving stability system of the vehicle. According to a further embodiment, the actual value of the rotational acceleration of the driving mechanism of the vehicle can be determined by means of an anti-lock brake system of the vehicle. According to a further embodiment, the actual value of the rate of yaw of the vehicle can be determined by means of a driving stability system of the vehicle.

According to yet another embodiment, a device for controlling an electronic brake of a vehicle, with the electronic brake comprising a braking element, an electric actuator, and a pressing element, which is arranged in such a way and is coupled to the electric actuator in such a way that it can be pressed against the braking element by means of the electric actuator, the device being operable to determine an actual value of a rotational acceleration of the driving mechanism of the vehicle, and to trigger the actuator as a function of the actual value of the rotational acceleration of the driving mechanism of the vehicle.

According to a further embodiment, the electronic brake can be an electromechanical brake, which is configured in the form of a wedge brake and the pressing element has a wedge element.

### BRIEF DESCRIPTION OF THE DRAWINGS

Examples of embodiments of the invention are shown and explained below by means of schematic drawings.

These drawings are as follows:

FIG. 1 shows a schematic representation of an electromechanical brake,

FIG. 2 shows a block diagram a first control unit for an electromechanical brake,

FIG. 3 shows a block diagram of a second control unit for an electromechanical brake,

FIG. 4 shows a block diagram of a third control unit for an electromechanical brake,

FIG. 5 shows a first flowchart of a program for controlling an electromechanical brake, and

FIG. 6 shows a second flowchart of a program for controlling an electromechanical brake.

Elements with the same design and function are identified in all the figures by the same reference symbols.

### DETAILED DESCRIPTION

According to an embodiment, in a method and a corresponding device for controlling an electronic brake of a vehicle, the electronic brake has a braking element, an electric actuator and a pressing element. The pressing element is arranged and is coupled to the electric actuator so that it can be pressed against the braking element by means of the electric actuator.

By means of the method, an actual value of a linear acceleration of the vehicle is determined. The actuator will be triggered as a function of the actual value of the linear acceleration of the vehicle.

According to an embodiment, the utilization of the measured value linear acceleration, which is already frequently detected in any event in the vehicle can be used very well for controlling the electromechanical brake, since the linear acceleration can be determined very precisely in a simple manner, thus rendering unnecessary a comparatively expensive determination of the friction force.

In accordance with an embodiment, a setpoint value of the linear acceleration of the vehicle is predetermined and the actuator is triggered in such a way that the actual value adapts itself to the setpoint value of the linear acceleration of the vehicle. This has the advantage that the electronic brake can be controlled directly by means of the measured quantity linear acceleration, which has already been made available in the vehicle.

In accordance with a further embodiment, an actual value of the rate of yaw of the vehicle is determined, and the setpoint value of the linear acceleration of the vehicle is determined as a function of the actual value of the rate of yaw of the vehicle. This has the advantage that the controllability of the electronic brake can be further improved by the rate of yaw measured quantity additionally made available.

In accordance with a further embodiment, an actual value of the rotational acceleration of a driving mechanism of the vehicle is determined. In addition, an actual value of the rate of yaw of the vehicle is determined. On the other hand, an estimated value of the rotational acceleration of the driving mechanism of the vehicle is determined from the actual value of the linear acceleration and the actual value of the rate of yaw of the vehicle, as well as an actual value of the braking torque of the driving mechanism of the vehicle is determined as a function of the actual value of the rotational acceleration and the estimated value of the rotational acceleration of the driving mechanism of the vehicle. In addition, a setpoint value of the braking torque of the driving mechanism of the vehicle is predetermined. The actuator is now triggered in such a way that the actual value adapts itself to the setpoint value of the braking torque of the driving mechanism of the vehicle. This is particularly advantageous, since the rate of yaw of the vehicle and the linear acceleration of the vehicle have frequently already been made available in some other way in the vehicle and in this way the setpoint value of the braking torque of the driving mechanism of the vehicle can in an indirect way be determined in an especially simple manner and in a very precise way.

In a further embodiment, a difference value between the vehicle speed and the rolling speed of the driving mechanism of the vehicle is determined as a function of the actual value of the rotational acceleration and the estimated value of the rotational acceleration of the driving mechanism of the vehicle. The actual value of the braking torque of the driving mechanism of the vehicle is determined from the difference value between the vehicle speed and the rolling speed of the driving mechanism of the vehicle. This is particularly advantageous, since the difference value representing the slip between the vehicle speed and the rolling speed of the driving mechanism of the vehicle and the known braking torque-slip relations make possible an especially simple indirect determination of the braking torque of the driving mechanism of the vehicle.

In accordance with a further embodiment, the actual value of the linear acceleration of the vehicle is determined by means of a driving stability system of the vehicle. Here it is advantageous that the measured quantity linear acceleration, has usually already been made available by a driving stability system, for example an electronic stability program (ESP), and can be used in order to implement the control of an electronic brake in an especially simple manner and in a very precise way.

In a further embodiment, the actual value of the linear acceleration of the vehicle is determined by means of an anti-lock brake system (ABS) of the vehicle. This is particularly advantageous, since the measured quantity linear acceleration, can be made available by the ABS that is available in nearly all the vehicles.

It can be particularly advantageous when the actual value of the rate of yaw of the vehicle is determined by means of a driving stability system of the vehicle. This has the advantage that the measured quantity rate of yaw, which has already been made available by a driving stability system (for example, ESP), can be used for a precise and simple control of the electronic brake.

In a further embodiment, the actual value of the rotational acceleration of the driving mechanism of the vehicle is determined by means of an anti-lock brake system of the vehicle. In this case the advantage is that the measured quantity rotational acceleration of the driving mechanism of the vehicle, made available in the ABS system can contribute towards a simple and precise control of the electronic brake. According to another embodiment, in a method and a corresponding device for controlling an electronic brake of a vehicle. The electronic brake having a braking element, an electric actuator and a pressing element, the pressing element is arranged and is coupled to the electric actuator so that it can be pressed against the braking element by means of the electric actuator. By means of the method, an actual value of a rotational acceleration of a driving mechanism of the vehicle is determined. The actuator is triggered as a function of the actual value of the rotational acceleration of a driving mechanism of the vehicle. This is particularly advantageous, since the utilization of the measured value rotational acceleration of the driving mechanism, which is already frequently detected in any event in the vehicle can be used very well for controlling the electronic brake, since the rotational acceleration of the driving mechanism of the vehicle can be determined very precisely and in a simple manner, thus rendering unnecessary a comparatively expensive determination of the friction force.

In accordance with an embodiment, a setpoint value of the rotational acceleration of the driving mechanism of the vehicle is predetermined, and the actuator is triggered in such a way that the actual value adapts itself to the setpoint value of the rotational acceleration of the driving mechanism of the vehicle. This has the advantage that the electronic brake can be controlled directly by means of the measured quantity rotational acceleration of the driving mechanism, which has already been made available in the vehicle.

In accordance with a further embodiment, an actual value of the rate of yaw of the vehicle is determined, and the setpoint value of the rotational acceleration of the driving mechanism of the vehicle is determined as a function of the actual value of the rate of yaw of the vehicle. This has the advantage that the controllability of the electronic brake can be further improved by the rate of yaw measured quantity additionally made available.

In accordance with a further embodiment, the actual value of the rotational acceleration of the driving mechanism of the vehicle is determined by means of a driving stability system of the vehicle. Here it is advantageous that the measured quantity rotational acceleration of the driving mechanism, has usually already been made available by a driving stability system, for example an electronic stability program (ESP), and can be used in order to implement the control of an electronic brake in an especially simple manner and in a very precise way.

In a further embodiment, the actual value of the rotational acceleration of the driving mechanism of the vehicle is determined by means of an anti-lock brake system (ABS) of the vehicle. This is particularly advantageous, since the measured quantity rotational acceleration of the driving mechanism, can be made available by the ABS that is available in nearly all the vehicles.

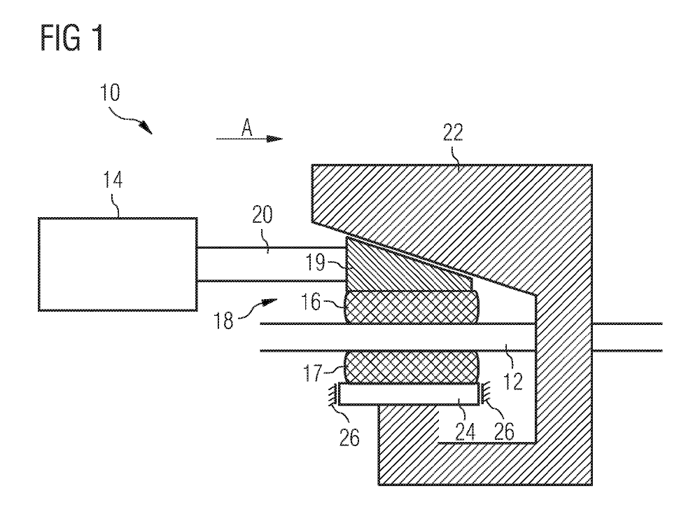

An electromechanical brake 10 (FIG. 1), which is embodied as a wedge brake in this case, comprises a braking element 12. This braking element can for example be embodied in the form of a rotatable brake disk, it may however also be a linear braking element, such as for example a cable pull. The braking element 12 is overlapped by a brake caliper 22. An electric actuator 14 is connected to a transducer 20, which can for example be embodied in the form of a spindle drive. The transducer 20 is connected to a pressing element 18, which exhibits a wedge element 19 and a brake pad 16. A further brake pad 17 is arranged on the side of the braking element 12 opposite the pressing element 18, said brake pad is supported by a holding element 24, which is mounted in a guide 26 and arranged on the brake caliper 22. The brake caliper 22 functions in accordance with the floating caliper principle, i.e. the brake caliper 22 is mounted in a displaceable manner on a carrier element, which is not shown here, and is connected in a fixed manner to the vehicle, perpendicular to a direction A which is the direction of movement of the braking element 12.

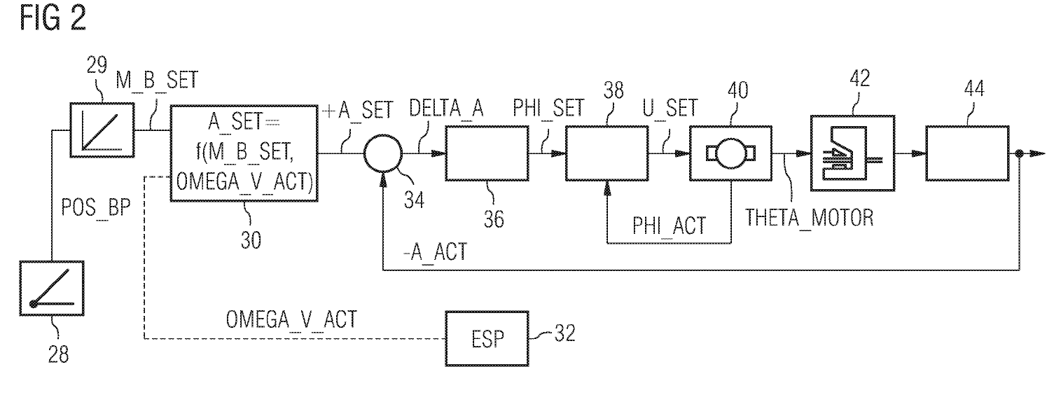

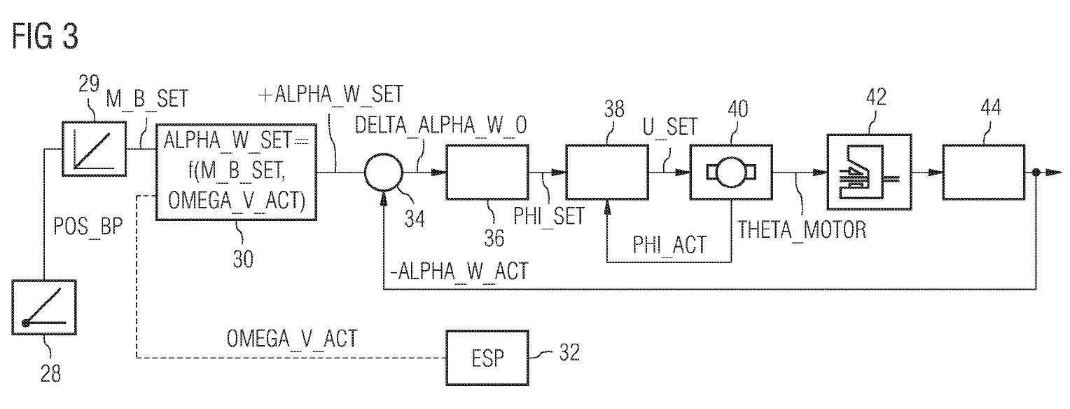

During a braking process, by means of the actuator 14, a force of the actuator is exerted on the wedge element 19 via the transducer 20, with the wedge element 19 able to be displaced in the direction A. Owing to the displacement of the wedge element 19 in the direction A, the brake pad 16 is pressed against the braking element 12. Since the brake caliper 22 functions in accordance with the floating caliper principle, the further brake pad 17 arranged on the side of the braking element 12 opposite the brake pad 16 is likewise pressed against the braking element 12. The braking element 12 is connected to a driving mechanism 44 shown in FIGS. 2 and 3. The driving mechanism 44 can for example be a wheel or a linear driving mechanism.

FIG. 2 shows a block diagram of a first embodiment for controlling the electromechanical brake of a vehicle.

From a brake pedal 28 with an associated setpoint value sensor, a position POS_BP is passed on to a brake pedal position braking torque converter 29. A setpoint value M_B_SET of the braking torque of the driving mechanism of the vehicle generated by the brake pedal position braking torque converter 29, is directed to an acceleration setpoint generator 30.

From the setpoint value M_B_SET of the braking torque of the driving mechanism of the vehicle, a setpoint value A_SET of the linear acceleration of the vehicle is now calculated. This value is then supplied to a first summing point 34 and compared there to an actual value A_ACT of the linear acceleration of the vehicle. A difference DELTA_A between the setpoint value A_SET and the actual value A_ACT of the linear acceleration of the vehicle is then supplied to a transducer setting angle regulator 36, which determines the setpoint value PHI_SET of a motor angle. By means of a motor regulator 38, a setpoint value U_SET of the motor voltage is made available and supplied to the motor 40. An actual value PHI_ACT of the motor angle is returned to the motor regulator 38. The motor regulator 38 and the motor 40 in this way together form an auxiliary control loop. An angular rotation THETA_MOTOR of the motor is passed on to a wedge brake 42. As a result, the brake pads 16, 17 can be pressed with a greater or lesser force against the braking element 12, which can for example be configured in the form of a disk brake. Thus the driving mechanism 44 of the vehicle can be slowed down to a greater or lesser extent. From a system of the vehicle gathering the data, for example an ESP system (ESP: Electronic Stability Program) or an anti-lock brake system ABS, the actual value A_ACT of the linear acceleration of the vehicle is now output and returned to the first summing point 34, in order to be compared again there to the setpoint value A_SET of the linear acceleration of the vehicle.

Should the actual value A_ACT of the linear acceleration of the vehicle not be able to be made available directly by the ABS system or the ESP system, then it is of course also possible to use a measured quantity detected in some other suitable way, such as for example the timing curve of a vehicle speed in order to determine the actual value A_ACT of the linear acceleration of the vehicle.

The method shown for controlling an electromechanical brake can be used for all the brakes of a vehicle, i.e. both for an individual brake, for example on a rear wheel of a motor cycle and for a number of brakes such as for instance for a number of wheels of a passenger car.

If the vehicle has an ESP system 32, as indicated in FIG. 2 by means of the broken line between the acceleration setpoint value sensor 30 and the ESP system 32, then this can likewise be used for controlling an electromechanical brake. To this end, an actual value signal OMEGA_V_ACT of the rate of yaw of the vehicle that is detected by means of the ESP system 32 is fed to the acceleration setpoint value sensor 30. In this case, the setpoint value A_SET of the linear acceleration of the vehicle is calculated from the setpoint value M_B_SET of the braking torque of the driving mechanism of the vehicle and the actual value OMEGA_V_ACT of the rate of yaw of the vehicle. During the inclusion of the actual value OMEGA_V_ACT of the rate of yaw of the vehicle it is possible to carry out, for each wheel of the vehicle to be slowed down, an individual controlling of the electromechanical brake assigned to the wheel in each case for a vehicle with a number of wheels.

FIG. 3 shows a block diagram of a further embodiment for controlling the electromechanical brake of a vehicle.

From the brake pedal 28 with the associated setpoint value sensor, the position POS_BP is passed on to the brake pedal position braking torque converter 29. The setpoint value M_B_SET of the braking torque of the driving mechanism of the vehicle generated by the brake pedal position braking torque converter 29, is directed to the acceleration setpoint generator 30.

From the setpoint value M_B_SET of the braking torque of the driving mechanism of the vehicle, a setpoint value ALPHA_W_SET of the rotational acceleration of the driving mechanism of the vehicle is now calculated. This value is then supplied to the first summing point 34 and compared there to an actual value ALPHA_W_ACT of the rotational acceleration of the driving mechanism of the vehicle. A difference DELTA_ALPHA_W_{—}0 between the setpoint value ALPHA_W_SET and the actual value ALPHA_W_ACT of the rotational acceleration of the driving mechanism of the vehicle, is then supplied to the transducer setting angle regulator 36. As in the control method shown in FIG. 2, the driving mechanism 44 of the vehicle can be slowed down to a greater or lesser degree by means of the wedge brake 42. The actual value ALPHA_W_ACT of the rotational acceleration of the driving mechanism of the vehicle is returned to the first summing point 34, in order to be compared again there to the setpoint value ALPHA_W_SET of the rotational acceleration of the driving mechanism of the vehicle.

This method for controlling an electromechanical brake can also be used for all the brakes of a vehicle, i.e. both for an individual brake, for example at a rear wheel of a motor cycle and for a number of brakes such as for instance for a number of wheels of a passenger car.

The inclusion of an ESP system 32 (broken line between the acceleration setpoint value sensor 30 and the ESP system 32 in FIG. 3) is possible in a similar way as with controlling the electromechanical brake in accordance with FIG. 2. In this case, the setpoint value ALPHA_W_SET of the rotational acceleration of the driving mechanism of the vehicle is calculated from the setpoint value M_B_SET of the braking torque of the driving mechanism of the vehicle and from the actual value OMEGA_V_ACT of the rate of yaw of the vehicle.

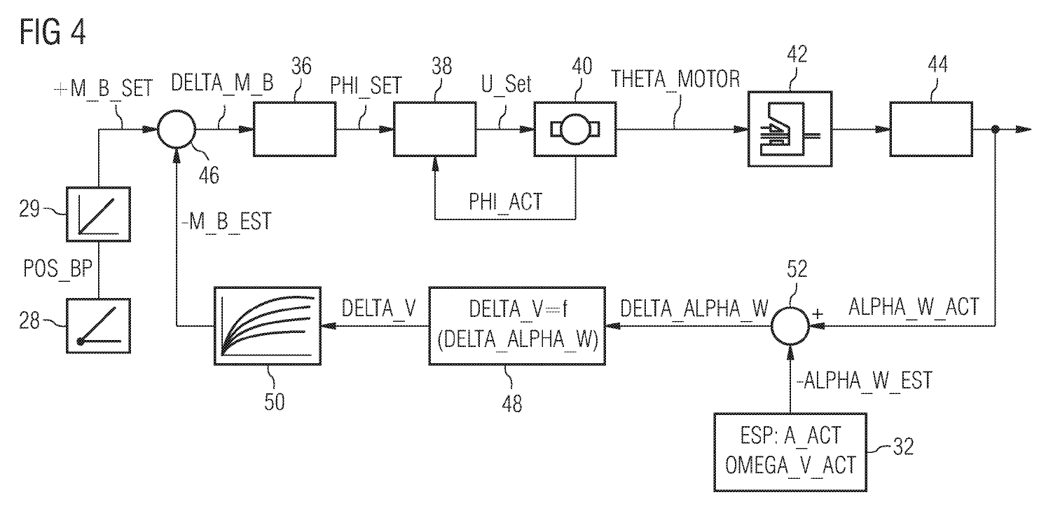

FIG. 4 shows a block diagram of a further embodiment of the method for controlling an electromechanical brake of a vehicle. Said method is in particular used for the case that the driving mechanism 44 is a wheel.

With the aid of the brake pedal 28, the position POS_BP of the brake pedal is predetermined and passed on to the brake pedal position braking torque converter 29, by means of which the setpoint value M_B_SET of the braking torque of the driving mechanism 44 of the vehicle is determined. This value is fed to a second summing point 46 and compared to an estimated value M_B_EST of the braking torque of the driving mechanism 44 of the vehicle. A difference DELTA_M_B between the setpoint value M_B_SET and the estimated value M_B_EST of the braking torque of the driving mechanism 44 of the vehicle is passed on to a transducer setting angle regulator 36, which makes available the setpoint value PHI_SET of a motor angle for the motor regulator 38. This outputs the setpoint value U_SET of the motor voltage to the motor 40, which on the other hand returns the actual value PHI_ACT of the motor angle to the motor regulator 38. By means of the angular rotation THETA_MOTOR of the motor, the pressing element 18 of the wedge brake 42 is pressed against the braking element 12. A resulting actual value ALPHA_W_ACT of the rotational acceleration of the driving mechanism 44 of the vehicle is fed to a third summing point 52, in order to be compared there to an estimated value ALPHA_W_EST of the rotational acceleration of the driving mechanism 44 of the vehicle. The estimated value ALPHA_W_EST of the rotational acceleration of the driving mechanism 44 of the vehicle is determined from the data of the ESP system 32. To this end, the actual value A_ACT of the linear acceleration of the vehicle and the actual value OMEGA_V_ACT of the rate of yaw of the vehicle are used. A difference DELTA_ALPHA W between the actual value ALPHA_W_ACT and the estimated value ALPHA_W_EST of the rotational acceleration of the driving mechanism 44 of the vehicle that is formed on the third summing point 52 is supplied to an integrator/converter unit 48. By means of the integrator/converter unit 48, a difference DELTA_V between the vehicle speed and the rolling speed of the driving mechanism 44 of the vehicle is determined, which is also referred to as slip. By means of a slip braking torque converter 50, the estimated value M_B_EST of the braking torque of the driving mechanism 44 of the vehicle can be determined. Thus provision has been made for an observer, by means of which, from the difference DELTA_ALPHA_W between the actual value ALPHA_W_ACT and the estimated value ALPHA_W_EST, the rotational acceleration of the driving mechanism 44 of the vehicle of the estimated value M_B_EST of the braking torque of the driving mechanism 44 of the vehicle is determined, which is finally supplied to the second summing point 46.

In the case of the method shown in FIG. 4 for controlling an electromechanical brake of a vehicle, the estimated value ALPHA_W_EST of the rotational acceleration can be determined individually for each wheel of the vehicle. For this reason, it is possible to carry out, for each wheel of the vehicle to be slowed down, an individual controlling of the associated electromechanical brake.

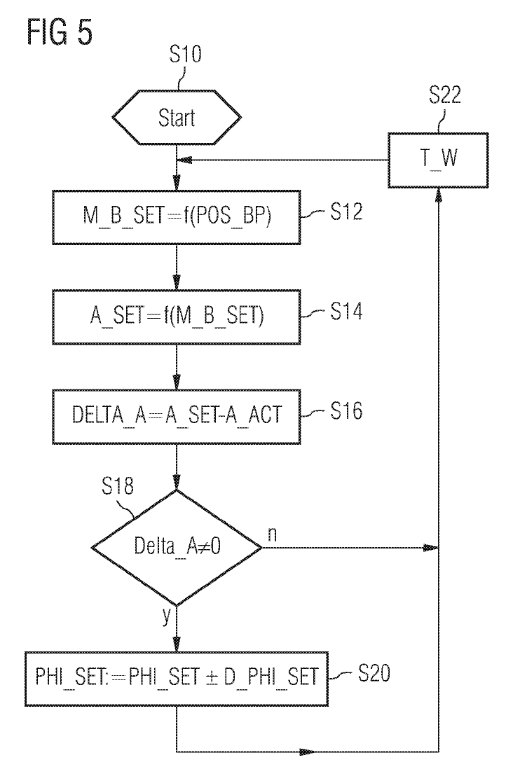

A program for controlling an electromechanical brake in the first embodiment in accordance with the method represented in FIG. 2 is shown in FIG. 5.

In a step S10, preferably near the beginning of an operating state reflecting the starting of the vehicle, the program is started and variables are initialized if necessary.

In a step S12, the setpoint value M_B_SET of the braking torque of the driving mechanism of the vehicle is determined from the position POS_BP of the brake pedal. In a step S14, the setpoint value A_SET of the linear acceleration of the vehicle is determined from the setpoint value M_B_SET of the braking torque of the driving mechanism of the vehicle. In a step S16, the difference DELTA_A between the setpoint value A_SET and the actual value A_ACT of the linear acceleration of the vehicle is determined.

In a step S18, a test is carried out in order to determine whether the difference DELTA_A is not equal to zero. If this has been fulfilled, the setpoint value PHI_SET of the motor angle is either increased or decreased by a predetermined change angle D_PHI_SET. If it is established in step S18 that the difference DELTA_A is equal to zero, then the processing of the program is continued in a step S22, in which the program is interrupted for a predetermined waiting time T_W, before it is continued in the step S12.

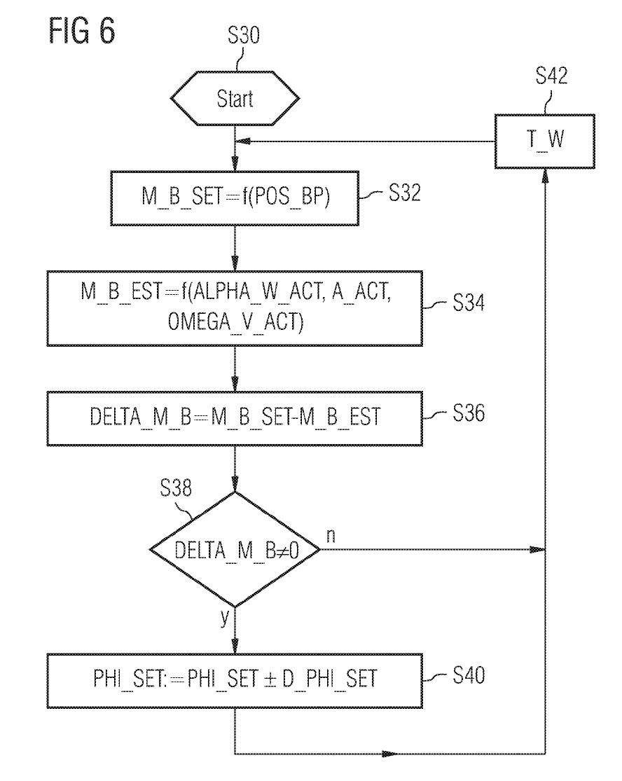

A further embodiment of a program for controlling an electromechanical brake in accordance with the method represented in FIG. 4 is shown in FIG. 6.

The program is started in a step S30, in which variables are also initialized if necessary.

In a step S32, the setpoint value M_B_SET of the braking torque of the driving mechanism of the vehicle is determined, wherefore the position POS_BP of the brake pedal is used. In a subsequent step S34, the estimated value M_B_EST of the braking torque of the driving mechanism of the vehicle is determined from the actual value ALPHA_W_ACT of the rotational acceleration of the driving mechanism of the vehicle, from the actual value A_ACT of the linear acceleration of the vehicle and from the actual value OMEGA_V_ACT of the rate of yaw of the vehicle. In a further step S36, the difference DELTA_M_B between the setpoint value M_B_SET and the estimated value M_B_EST of the braking torque of the driving mechanism of the vehicle is determined.

In a further step S38, a test is carried out in order to determine whether the difference DELTA_M_B between the setpoint value M_B_SET and the estimated value M_B_EST of the braking torque of the driving mechanism of the vehicle is not equal to zero. If the difference DELTA_M_B is equal to zero, then the setpoint value PHI_SET of the motor angle can remain unchanged and the processing of the program is continued in a step S42, in which the program is interrupted for a predetermined waiting period T_W, before step S32 is carried out again. If the difference DELTA_M_B is not equal to zero, then in a step S40, the setpoint value PHI_SET of the motor angle is increased or decreased by an amount D_PHI_SET. Subsequent to the step S40, the processing is continued in the step S42, in which the program is interrupted for the predetermined waiting period T_W, before the processing is continued again in the step S32.

What is claimed is:

1. A method for controlling an electronic, or electromechanical brake of a vehicle, the braking comprising
a braking element,
an electric actuator, and
a pressing element, which is arranged in such a way and is coupled to the electric actuator in such a way that it can be pressed against the braking element by means of the electric actuator, the method comprising the steps of:
determining an actual value of a linear acceleration of the vehicle, and
triggering the actuator as a function of the actual value of the linear acceleration of the vehicle.

2. The method for controlling an electronic brake of a vehicle according to claim 1, wherein
a setpoint value of the linear acceleration of the vehicle is predetermined, and
the actuator is triggered in such a way that the actual value adapts itself to the setpoint value of the linear acceleration of the vehicle.

3. The method for controlling an electronic brake of a vehicle according to claim 2, wherein an actual value of a rate of yaw of the vehicle is determined, and the setpoint value of the linear acceleration of the vehicle is determined as a function of the actual value of the rate of yaw of the vehicle.

4. The method for controlling an electronic brake of a vehicle according to claim 1, wherein
an actual value of the rotational acceleration of a driving mechanism of the vehicle is determined,
an actual value of the rate of yaw of the vehicle is determined,
from the actual value of the linear acceleration and from the actual value of the rate of yaw of the vehicle, an estimated value of the rotational acceleration of the driving mechanism of the vehicle is determined,
as a function of the actual value of the rotational acceleration and the estimated value of the rotational acceleration of the driving mechanism of the vehicle, an estimated value of the braking torque of the driving mechanism of the vehicle is determined,
a setpoint value of the braking torque of the driving mechanism of the vehicle is predetermined, and
the actuator is triggered in such a way that the estimated value adapts itself to the setpoint value of the braking torque of the driving mechanism of the vehicle.

5. The method for controlling an electronic brake of a vehicle according to claim 4, wherein
a difference value between the vehicle speed and the rolling speed of the driving mechanism of the vehicle is determined as a function of the actual value of the rotational acceleration and the estimated value of the rotational acceleration of the driving mechanism of the vehicle, and
the estimated value of the braking torque of the driving mechanism of the vehicle is determined from the difference value between the vehicle speed and the rolling speed of the driving mechanism of the vehicle.

6. The method for controlling an electronic brake of a vehicle according to claim 1, wherein the actual value of the linear acceleration of the vehicle is determined by means of a driving stability system of the vehicle.

7. The method for controlling an electronic brake of a vehicle according to claim 1, wherein the actual value of the linear acceleration of the vehicle is determined by means of an anti-lock brake system of the vehicle.

8. The method for controlling an electronic brake of a vehicle according to claim 4, wherein the actual value of the rotational acceleration of the driving mechanism of the vehicle is determined by means of an anti-lock brake system of the vehicle.

9. The device for controlling an electronic or electromechanical, brake of a vehicle, wherein the brake comprises
a braking element,
an electric actuator, and
a pressing element, which is arranged in such a way and is coupled to the electric actuator in such a way that it can be pressed against the braking element by means of the electric actuator, with the device being operable
to determine an actual value of a linear acceleration of the vehicle, and
to trigger the actuator as a function of the actual value of the linear acceleration of the vehicle.

10. The method for controlling an electronic, or electromechanical, brake of a vehicle, wherein the brake comprises
a braking element,
an electric actuator, and
a pressing element, which is arranged in such a way and is coupled to the electric actuators in such a way that it can be pressed against the braking element by means of the electric actuator the method comprising the steps of
determining an actual value of a rotational acceleration of a driving mechanism of the vehicle, and
triggering the actuator as a function of the actual value of the rotational acceleration of the driving mechanism of the vehicle.

11. The method according to claim 10,
a setpoint value of the rotational acceleration of the driving mechanism of the vehicle is predetermined, and
the actuator is triggered in such a way that the actual value adapts itself to the setpoint value of the rotational acceleration of the driving mechanism of the vehicle.

12. The method according to claim 11, wherein an actual value of a rate of yaw of the vehicle is determined and the setpoint value of the rotational acceleration of the driving mechanism of the vehicle is determined as a function of the actual value of the rate of yaw of the vehicle.

13. The method according to claim 10, wherein actual value of the rotational acceleration of the driving mechanism of the vehicle is determined by means of a driving stability system of the vehicle.

14. The method according to claim 10, wherein actual value of the rotational acceleration of the driving mechanism of the vehicle is determined by means of an anti-lock brake system of the vehicle.

15. The method according to claim 3, wherein the actual value of the rate of yaw of the vehicle is determined by means of a driving stability system of the vehicle.

16. A device for controlling an electronic brake of a vehicle, with the electronic brake comprising
a braking element,
an electric actuator and
a pressing element, which is arranged in such a way and is coupled to the electric actuator in such a way that it can be pressed against the braking element by means of the electric actuator, with the device being operable
to determine an actual value of a rotational acceleration of the driving mechanism of the vehicle, and
to trigger the actuator as a function of the actual value of the rotational acceleration of the driving mechanism of the vehicle.

17. The device according to claim 9 wherein, the electronic brake is an electromechanical brake, which is configured in the form of a wedge brake and the pressing element has a wedge element.

18. The device according to claim 16, wherein the electronic brake is an electromechanical brake, which is configured in the form of a wedge brake and the pressing element has a wedge element.
